(19) United States
(12) Patent Application Publication
(10) Pub. No.: US 2026/0349667 A1
(43) Pub. Date: Nov. 5, 2026

(54) ITERATIVE PROMPT VALIDATION FOR CODE COMPLETION

(71) Applicant: MICROSOFT TECHNOLOGY LICENSING, LLC, Redmond, WA (US)

(72) Inventors: Ion TODIREL, Bellevue, WA (US); Bogdan Ionut MIHALCEA, Sammamish, WA (US)

(21) Appl. No.: 19/195,212

(22) Filed: Apr. 30, 2025

(51) Int. Cl. G06F 8/33; G06F 8/35; G06F 11/3668

(52) U.S. Cl. CPC G06F 8/33; G06F 8/35; G06F 11/3688

(57) ABSTRACT

Systems are provided for facilitating iterative prompt validation for code completion by at least introducing a real-time validation mechanisms into the code completion processes. These mechanisms involve the compiling of generated code suggestions and checking for errors iteratively during the code generation, suggestion and completion processes. If errors are detected, the system refines prompts and obtains new code suggestions until valid solutions are achieved and/or accepted. By leveraging existing build systems and unit tests, this approach ensures that the generated code is not only syntactically correct but also functionally accurate and reliable, thereby improving the efficiencies associated with code generation.

### BACKGROUND

In software development, autocompletion and auto-suggestion tools are beneficial for enhancing productivity and reducing the cognitive load on developers. These tools are often integrated into modern integrated development environments (IDEs) and provide real-time code suggestions based on the context of the code being written. While these tools have significantly improved the efficiency of coding, they are not without limitations and challenges.

One of the primary issues with existing autocompletion and auto-suggestion tools, for example, is their tendency to suggest outdated or deprecated versions of code. This can occur when the underlying models are not updated with the latest changes in libraries, frameworks, or APIs. As a result, developers may inadvertently accept suggestions that are no longer valid, leading to compilation errors and wasted time in debugging and correcting these issues.

Some autocompletion tools leverage machine learning models that are trained to process initial inputs (e.g., initial text characters or initial code segments) to predict subsequent suggested completions or modifications to the initial inputs (e.g., complete words or code elements, subsequent code segments, etc.).

The machine learning models are trained on training data comprising complete words and samples of code. They typically use a self-attention mechanism to understand the context of initial inputs to make predictions for subsequent content. To enable functionality for different programming languages, the models are often trained on large code repositories to learn the patterns and structures of different programming languages.

Unfortunately, models can sometimes experience a phenomenon known as “hallucinations,” where the model generated suggestions are syntactically correct (based on training with similar programming languages), but may be semantically incorrect or nonsensical due to a misunderstood intention or context associated with the content being processed. These hallucinations can be particularly problematic because they may not be immediately apparent to the developer. The suggested code might compile successfully but fail at runtime due to logical errors or incorrect assumptions associated with the hallucination.

Additionally, even when the suggested code can be successfully compiled, it may not operate correctly during runtime. This can happen for several reasons, including incorrect interactions between different APIs, missing dependencies, or improper configuration settings. The current tools lack a robust mechanism to validate the generated code against the actual build and runtime environment, leading to potential runtime errors that are difficult to diagnose and fix.

In view of the foregoing, there is an ongoing need and desire for improved systems and methods for facilitating autocompletion and auto-suggestion functionality for code development software and interfaces.

The subject matter claimed herein is not limited to embodiments that solve any disadvantages or that operate only in environments such as those described above. Rather, this background is only provided to illustrate one example technology area where some embodiments described herein may be practiced.

### SUMMARY OF THE INVENTION

Systems and methods are provided for facilitating iterative prompt validation for code completion.

In some aspects, the techniques described herein relate to a method implemented by a computing system for facilitating iterative prompt validation for code completion, the method including: the computing system generating a prompt for code development, the prompt based on and user input entered at a code development interface as well as code context of a codebase being developed with the code development interface; the computing system sending a request with the prompt to one or more remote services and/or models capable of processing the request and generating a response based on the prompt, the response including suggested code; the computing system, prior to the suggested code being displayed at the code development interface, performing one or more validation tests with the suggested code; the computing system, in response to a fail event associated with the suggested code failing the one or more validation tests: refraining from displaying the suggested code at the code development interface; updating the prompt based on the fail event; causing a new request to be generated and transmitted to the one or more remote services and/or models based on the updated prompt; and receiving a new response based on the new request, the new response including new suggested code; the computing system, prior to the new suggested code being displayed at the code development interface, performing the one or more validation tests with the new suggested code; and the computing system, in response to the one or more validation tests being successfully performed with the new suggested code, causing the new suggested code to be displayed at the code development interface.

In some aspects, the techniques described herein relate to a method, wherein the one or more validation tests includes a language services syntactic test, a semantic test, a compile test and/or a compiled code runtime execution test.

In some aspects, the techniques described herein relate to a method, wherein the method further includes the computing system, in response to identifying a user-initiated event that suggests a rejection of the new suggested code: generating a newly updated prompt based on the updated prompt and the user-initiated event; causing a subsequent request to be generated and transmitted to the one or more remote services and/or models based on the newly updated prompt; and receiving a subsequent response based on the subsequent request, the subsequent response including new suggested code; and prior to the new suggested code being displayed at the code development interface, performing the one or more validation tests with the new suggested code.

In some aspects, the techniques described herein relate to a method, wherein the method further includes the computing system, in response to the one or more validation tests being successfully performed with the new suggested code, causing the new suggested code to be displayed at the code development interface.

In some aspects, the techniques described herein relate to a method, wherein the method further includes the computing system detecting user input rejecting the new suggested code and deleting the new suggested code from the code development interface or, alternatively, detecting user input accepting the new suggested code and incorporating the new suggested code into the codebase at the code development interface.

In some aspects, the techniques described herein relate to a method, wherein the method further includes the computing system, in response to a new fail event associated with the new suggested code failing the one or more validation tests: refraining from displaying the new suggested code at the code development interface; updating the prompt based on the new fail event; causing a subsequent new request to be generated and transmitted to the one or more remote services and/or models based on the updated prompt; and receiving a subsequent new response based on the subsequent new request, the subsequent new response including subsequent new suggested code.

In some aspects, the techniques described herein relate to a computing system including: one or more hardware processor; and one or more hardware storage device having stored computer-executable instructions that are executable by the one or more hardware processor to cause the computing system to implement the functionality disclosed herein.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the advantages and features of the systems and methods described herein can be obtained, a more particular description of the embodiments briefly described above will be rendered by reference to specific embodiments thereof which are illustrated in the appended drawings. Understanding that these drawings depict only typical embodiments of the systems and methods described herein, and are not therefore to be considered to be limiting of their scope, certain systems and methods will be described and explained with additional specificity and detail through the use of the accompanying drawings in which:

FIG. 1 illustrates a computing environment that may be utilized to implement the disclosed embodiments for facilitating iterative prompt validation for code completion.

FIG. 2 illustrates a flowchart of acts associated with methods for facilitating iterative prompt validation for code completion.

FIGS. 3-6 illustrates example processing flows for facilitating iterative prompt validation for code completion.

### DETAILED DESCRIPTION OF THE INVENTION

As disclosed herein, systems and methods are provided for facilitating iterative prompt validation for code completion.

Beneficially, the disclosed embodiments facilitate iterative prompt validation for code completion by at least introducing a real-time validation mechanisms into the code completion processes. These mechanisms involve the compiling of generated code suggestions and checking for errors iteratively during the code generation, suggestion and completion processes. If errors are detected, the system refines prompts and obtains new code suggestions until valid solutions are achieved and/or accepted. By leveraging existing build systems and unit tests, this approach ensures that the generated code is not only syntactically correct but also functionally accurate and reliable, thereby improving the efficiencies associated with code generation.

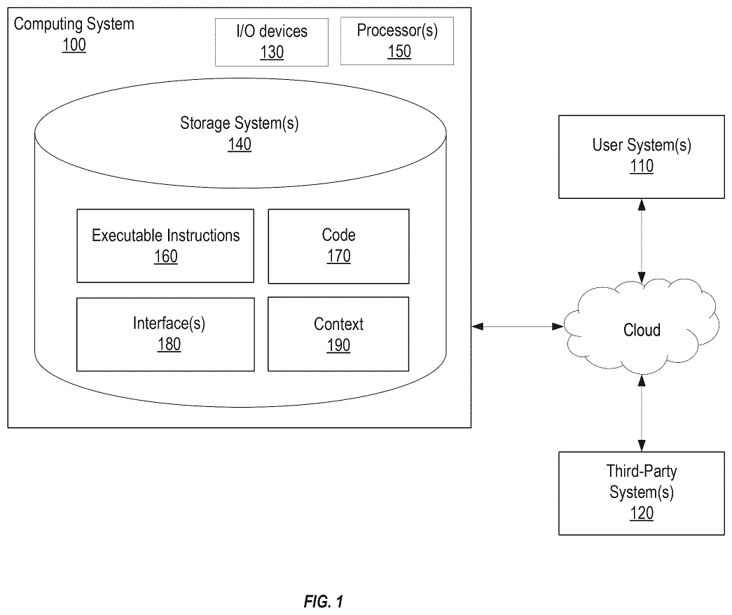

Attention is now directed to FIG. 1, which illustrates a computing system that can comprise and/or be utilized to facilitate the embodiments described herein. As shown, the computing system 100 is in communication with one or more user system(s) 110 and/or third-party system(s) 120. In some implementations, the user system(s) 110 and third-party system(s) 120 are remotely located from the computing system 100 and are independently controlled computing systems. In other implementations, the user system(s) 110 and/or third-party system(s) 120 comprise distributed components of the computing system 100, such that they share storage and processing capabilities.

Computing system 100 is connected to the other user system(s) 110 and third-party system(s) 120 through a network of wired and/or wireless connections, such as currently represented as the cloud.

Each of the illustrated systems includes input and output devices (I/O devices 130) for receiving inputs and rendering outputs, respectively, even though they are only explicitly shown for computing system 100. Non-limiting examples of input devices include microphones, keyboards, mouse devices, touch pads, and camera sensors. Non-limiting examples of output devices include speakers, desktop display screens, mixed-reality display devices, and haptic feedback devices.

The disclosed systems also include one or more storage system(s) 140 of volatile and/or non-volatile storage and one or more hardware processor(s) 150 configured to execute computer-executable instructions 160 stored in the storage system(s) 140 to cause the computing system 100 to implement the methods and functionality disclosed herein.

The storage system(s) 140 also store the code 170 (i.e., programing files, codebases) being developed, as well as the programs and other interfaces 180 in which the code is being developed. An integrated development environment (IDE) is an exemplary interface 170 in which code can be developed.

In some instances, storage system(s) also store context 190 for the code that is being developed and which can be referenced in prompts for queries or requests for suggested code to use in the code development, as will be described in more detail below.

This context information can include, for example, metadata or datafiles that identify information about a codebase being developed, as well as the developer. In this regard, context can include user context information (e.g., information about a particular user or entity associated with the development or use of the code), task and application context (e.g., a function or manner of utilizing the code in an application), historical use data (e.g., how the code has been used in other applications), location or device context (e.g., systems and enterprises that utilize the code), codebase contexts (e.g., specific programming language and the types of classes, functions, and declarations used in the code, as well as dependencies and specific parts of a codebase that will be affected or modified during a development process), temporal context (e.g., past, present, and future use), and social or enterprise contexts (e.g., user or group assignment, privileges, confidentiality).

Although not explicitly shown, other data used to implement the functionality described herein can be stored within the storage system(s) 140, such as, but not limited to validation tests that are described herein. In particular, users can develop and store their own validation tests to be applied in addition to or in the alternative to validation tests managed by third-party entities and remote systems. Regardless of which validation tests are used, the validation testing is customizable to utilize one or more local validation tests and/or one or more remote validation tests.

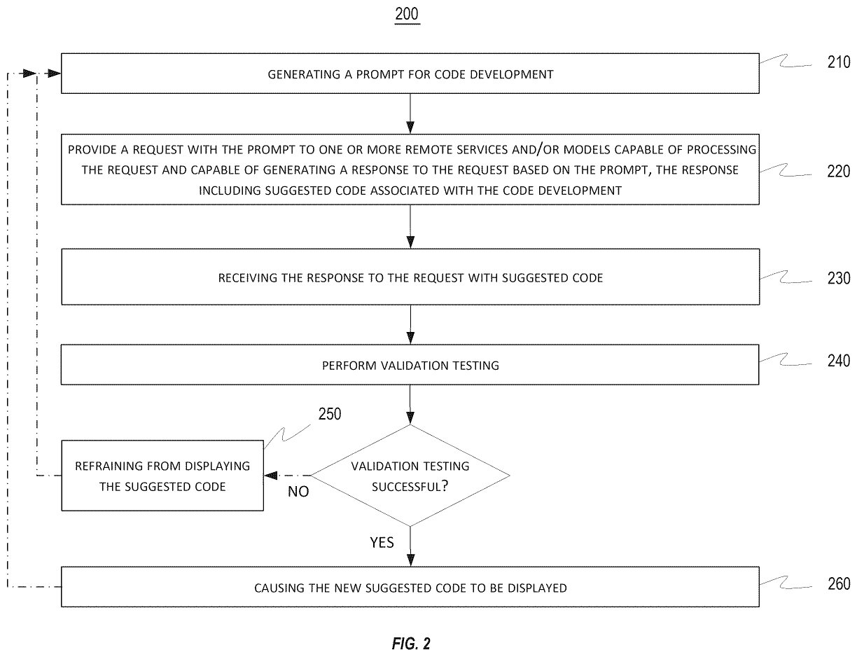

It will be appreciated that computing system 100 can be utilized to implement the disclosed methods, including the methods associated with the acts that are illustrated in flowchart 200 of FIG. 2, as described in more detail below.

As shown, in FIG. 2, the acts implemented by the disclosed methods for facilitating iterative prompt validation for code completion include the generation of a prompt for code development (act 210). This act includes obtaining user input entered at an IDE, for example, such as when a user types code or otherwise provides input into the IDE.

The system also obtains code context for the code that is being developed. The code context includes, in some instances, context information specifically related to the user input, such as task, application and codebase context information. This can include, among other things, the segments of code preceding or following the code being entered by the user and information about the names, classes, files or functions associated with the lines of code proximate the newly entered user input. This context can also include any of the other context referenced above, such as user context information, historical use data, location or device context, temporal context, and social or enterprise context.

The system uses at least a portion of the user input (e.g., typed characters and/or selected portions of code), as well as corresponding code context of the codebase being developed with the code development interface to create a prompt for a third-party service or model (e.g., a large language model (LLM)), that is capable of processing the request and capable of generating a response based on the prompt. In some instances, the prompt includes a predetermined quantity of lines of code preceding the text entered or selected by the user, as well as other context information that identifies a programming language being used and/or a program type and functionality associated with the code being developed and that is currently loaded into the IDE that the user is entering or selecting code within.

The prompt is then formatted into a request and provided to the one or more remote services and/or models capable of processing the request into a response that includes suggested code to be used as auto-completions, replacement code or other segments of code that can be incorporated into the codebase being developed (act 220).

Then, the computing system receives the response to the request from the corresponding third-party services and/or models (act 230). The response includes the aforementioned suggested code.

However, unlike conventional systems that obtain and provide auto-completion suggestions automatically when received, the current embodiments perform a validation with the suggested code, prior to displaying it to the user at the code development interface. This way, the user will not be presented with an option to incorporate suggested code that could inadvertently introduce errors into the codebase.

In some instances, when the validation testing is performed with the suggested code (act 240) and results in a test fail event, then the system refrains from displaying the suggested code at all (act 250).

In contrast, when validation testing with the suggested code (act 240) is performed successfully, then the system causes the suggested code to be displayed for selection by a user for incorporation into the codebase being developed (act 260).

Different types of unit tests can be used to perform the validation testing (act 240). The unit tests can include any type of automated test designed to validate the functionality, correctness, and reliability of specific sections of code, such as functions, methods, or classes. In some instances, the performance of the validation testing includes incorporating the suggested code into portions of the codebase being developed and running a test on the codebase with the incorporated suggested code for syntactical and/or semantical correctness.

The tests run during this validation can be run as separate programs in the background, so that the developer does not see the execution of the validation test taking place.

It will be appreciated that different types of unit tests can be created to be run for different types of programs and programming modules. The tests may include replacing parts of the codebase (after incorporating the suggested code), such as by replacing variables with different values and ensuring the code executes correctly without errors. IN some instances, the suggested code replaces portions of the codebase prior to or during testing.

Those of skill in the art will realize that the method of testing varies depending on the language and type of software (GUI, command-line, library) being tested. In some instances, the unit tests involve moving parts of the code to different locations to check if the code still functions correctly. For example, moving a block of code to a different function or module and ensuring it integrates seamlessly.

In some embodiments, the validation testing includes a language services syntactic test or a semantic test of the codebase incorporating the suggested code.

In some embodiments, the validation testing includes a compile test and is performed to see if the codebase can be compiled without errors after incorporating the suggested code.

Other examples of validation testing include compiling the codebase with the suggested code and performing a runtime execution of the codebase to see if the compiled program can execute without error and/or to perform a desired functionality.

In some instances, such as when a validation test is failed with the suggested code, the system iterates the aforementioned acts, such as causing a new request to be generated and transmitted to the one or more remote services and/or models based on an updated prompt that is updated to reflect the corresponding failed validation testing event (act 210, act 220).

Then, after receiving a new response based on the new request, which includes new suggested code, the system performs additional validation testing with the new suggested code (act 230, act 240).

Then, in response to the one or more validation tests being successfully performed with the new suggested code, the system causes the new suggested code to be displayed at the code development interface (act 260).

Notably, iterative processing of prompts and responses, including the validation of the suggested code included in the responses, can also be further continued as a result of a user rejecting any suggested code that is presented for auto-completion/incorporation into the codebase. For instance, when a user rejects an auto-completion suggestion presented to the user with the suggested code (e.g., by receiving new input text that does not select the suggested code), the system can generate a newly updated prompt with information reflecting that the suggested code has been rejected (along with the other information that was previously provided in the underlying prompt). This can further trigger the generation of a new response with a new suggestion, as generated by the LLM receiving the prompt. This newly generated suggestion can then be presented to the user for possible acceptance and incorporation into the codebase.

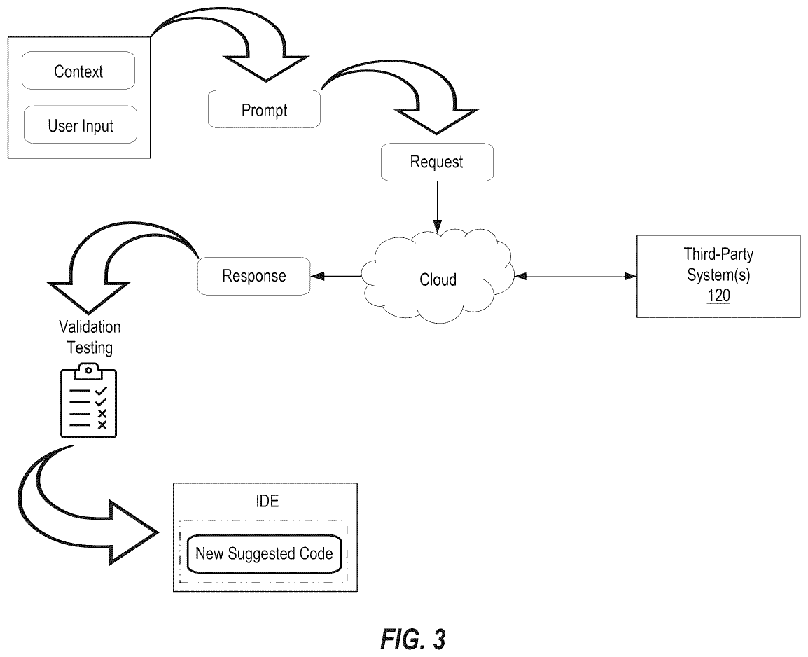

Attention will now be directed to processing flow shown in FIGS. 3-6, which illustrate additional examples of the foregoing methods.

FIG. 3 illustrates a prompt, which is based on user input and corresponding code context for an underlying codebase that is being developed. This prompt, for example, can be generated in response to a user entering or selecting code segments or even individual characters within the code development interface where the underlying codebase is being developed. This processing flow further illustrates how the prompt is processed into a request that is transmitted to a third-party system 120. The request is a request for code suggestions to be provided within the code development interface for incorporation and/or to provide an auto-complete suggestion. The third-party system 120 includes a service and/or model that processes the request and generates a response with suggested code that can be used as an auto-complete suggestion or other input for facilitating the development of the underlying codebase. The suggested code is based on the content of the prompt submitted with the request. The service and/or model that processes the request is configured with rules or training to facilitate the generation of a corresponding code suggestion based on user input and code context.

Once the response is received, the system performs validation testing, as described above, to ensure that that the code suggestion will not introduce errors into the underlying codebase if it is incorporated and used. According to preferred embodiments, the validation testing is performed prior to and/or without displaying the code suggestion in the code development environment (e.g., IDE).

Then, once the validation testing is completed, the code suggestion can be displayed in the IDE. In some embodiments, the code suggestion is not ever displayed if it fails the validation testing and is only displayed once the validation testing is successfully completed.

In some instances, the validation testing includes a single validation test (e.g., a single unit test). In other instances, the validation testing includes a plurality of different validation tests (e.g., a plurality of unit tests). The validation testing can include any combination of one or more syntactic, semantic, compile and runtime tests.

In some instances, the validation testing is performed by one or more third-party system(s) 120 remotely from the system presenting the code development environment. This can be accomplished, for example, by sending coherent segments of the underlying code, which has been modified with the suggested code segment, to a third-party testing service.

In other embodiments, the system incorporates the suggested code into a copy of the underlying code and tests the copy to verify it can be compiled and/or executed as intended without introducing any errors or without causing any fail events.

After the validation is successfully completed, with no fail events with the validation testing based on the suggested code, the suggested code is presented to the user for incorporation into the underlying codebase being developed.

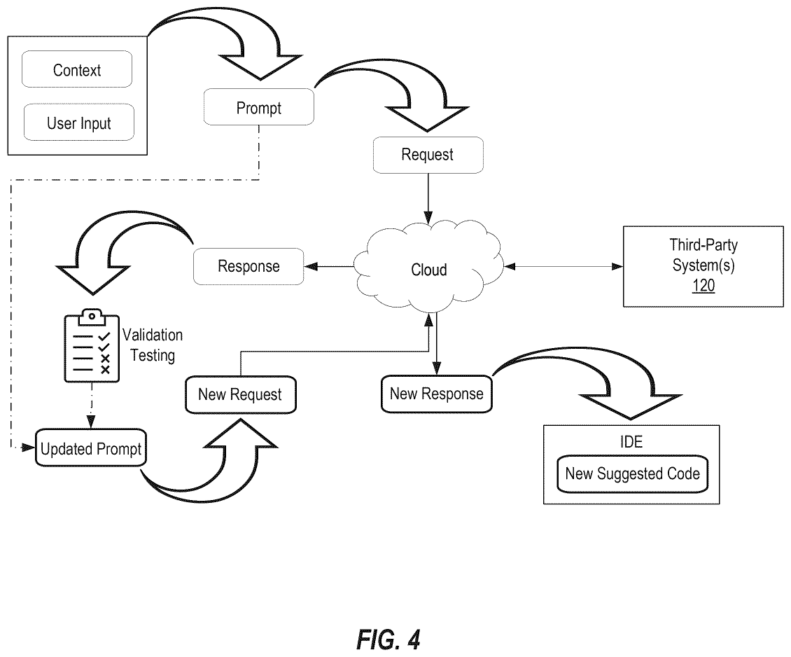

FIG. 4 illustrates a similar processing flow, but wherein if validation testing results in a failure event, the original prompt can be updated (or a new prompt can be generated, which is also referred to herein as an updated prompt), and that updated prompt can be submitted to the third-party system(s) 120 to obtain a new response with suggested code.

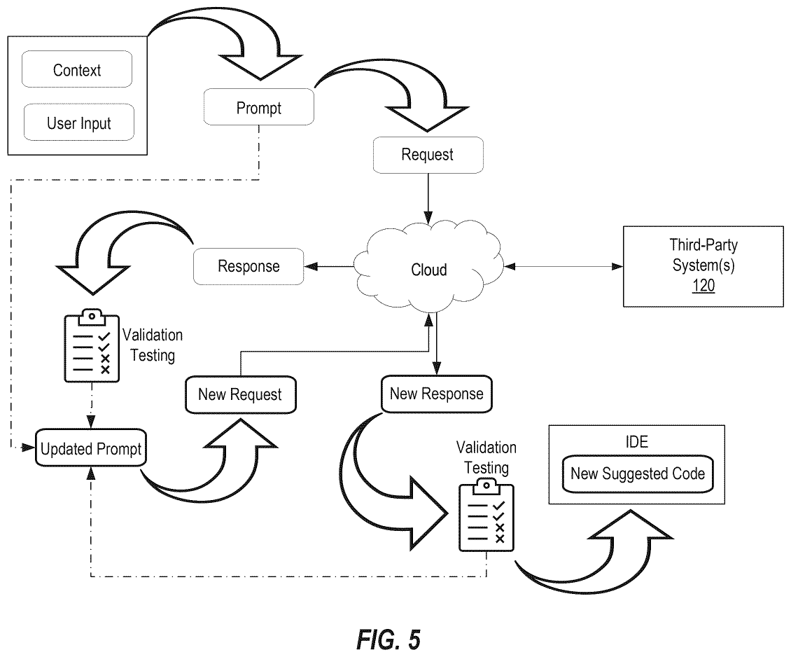

In some embodiments, the new suggested code can then be presented in the IDE without validation testing, as shown (as shown in FIG. 4). Or, more preferably, the new suggested code will only be presented once it has completed successful validation testing, as shown in FIG. 5. The validation testing on the new suggested code can include the same and/or different validation tests used for the original suggested code included in the original response to the original prompt.

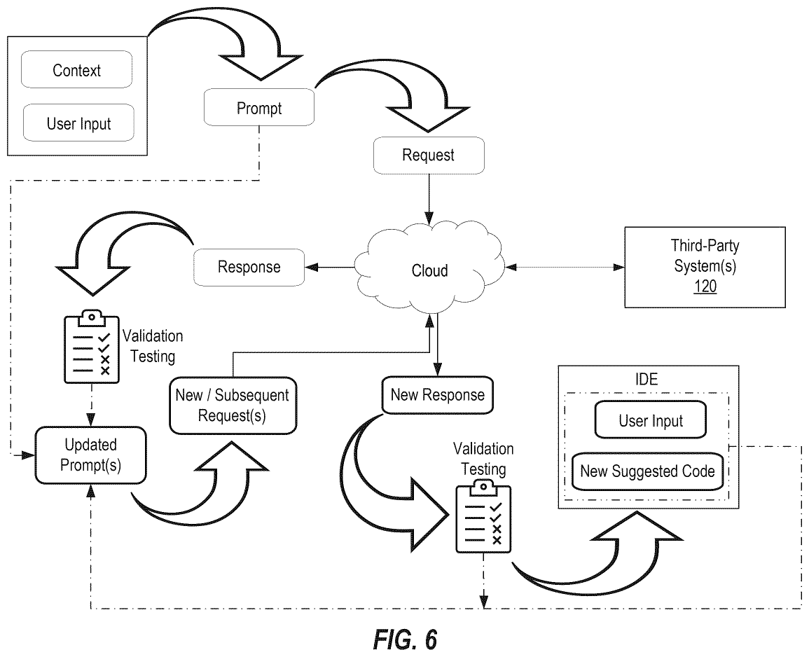

FIG. 6 illustrates how any new suggested code undergoes validation testing and can trigger additional iterations of the processes for generating new/subsequent prompts and requests and the processing of new responses with new suggested code, (e.g., when the validation testing on the new suggested code results in a fail event, such as an incompatibility error, uncompilable error, runtime error, syntax error, semantic error, or other validation testing error).

FIG. 6 also illustrates how the validation testing of any new suggested code can also trigger the display of the new suggested code within the code development environment for acceptance or rejection by new user input. When a user accepts the new suggested code (e.g., such as accepting an auto-complete suggestion with the new suggested code), the new suggested code is incorporated into the underlying codebase being developed. Alternatively, when a user rejects the new suggested code (e.g., keeps typing without accepting the auto-suggestion with the new suggested code), the system will trigger additional iterations of the processes described above, including the generation of new prompts and requests, processing responses and validation testing the code suggestions in the responses.

With regard to the validation tests and validation testing described herein, it will be appreciated that the validation testing is customizable and can include the use of one or more local validation tests, which may be created by the user or a third-party, as well as one or more remotely stored validation tests. In some embodiments, not illustrated, the IDE's or other code development interfaces are configured with menus and selectable options for enabling a user to specify which validation test(s) will be used during the validation testing and/or under which circumstances to utilize different validation tests. These interfaces may also provide tools for developing the different validation tests and/or for setting thresholds to define a successful validation test or a fail event associated with a validation test applied to the codebases being developed with the different code suggestions.

In view of the foregoing, and as noted earlier, it will be appreciated that the disclosed embodiments can be utilized to facilitate iterative prompt validation for code completion by at least introducing a real-time validation mechanisms into the code completion processes. These mechanisms involve the compiling of generated code suggestions and checking for errors iteratively during the code generation, suggestion and completion processes. If errors are detected, the system refines prompts and obtains new code suggestions until valid solutions are achieved and/or accepted. By leveraging existing build systems and unit tests, this approach ensures that the generated code is not only syntactically correct but also functionally accurate and reliable, thereby improving the efficiencies associated with code generation.

As also noted earlier, the disclosed methods and functionality may be performed by a computing system, such as computing system 100, which may take various different forms and which may include and/or be in communication with one or more user systems and third-party system. For example, computing system 100 may be embodied as a tablet, a desktop, a laptop, a mobile device, or a standalone device, such as those described throughout this disclosure. Computing system 100 may also be a distributed system that includes one or more connected computing components/devices that are in communication with computing system 100.

In its most basic configuration, computing system 100 includes various different components, such as the referenced processors. Without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computing system 100. The different components, modules, engines, and services described herein may be implemented as objects or processors that execute on computing system 100 (e.g. as separate threads).

The referenced storage system(s) may be physical system memory, which may be volatile, non-volatile, or some combination of the two. The term “memory” may also be used herein to refer to non-volatile mass storage such as physical storage media. If computing system 100 is distributed, the processing, memory, and/or storage capability may be distributed as well.

The storage system(s) may include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 100 may also be connected (via a wired or wireless connection) to external sensors (e.g., one or more remote cameras) or devices via a network defined as one or more data links and/or data switches that enable the transport of electronic data between computer systems, modules, and/or other electronic devices. For example, computer system 100 can communicate with any number of devices or cloud services to obtain or process data. In some cases, the network may itself be a cloud network (e.g., the cloud shown in FIG. 1). Furthermore, computer system 100 may also be connected through one or more wired or wireless networks to remote/separate computer systems(s) that are configured to perform any of the processing described with regard to computer system 100.

When information is transferred, or provided, over a network (either hardwired, wireless, or a combination of hardwired and wireless) to a computer, the computer properly views the connection as a transmission medium. Computer system 100 will include one or more communication channels that are used to communicate with the network. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The embodiments described are to be considered in all respects only as illustrative and not restrictive. The scope of the invention is, therefore, indicated by the appended claims rather than by the foregoing description. All changes which come within the meaning and range of equivalency of the claims are to be embraced within their scope.

The present invention can also be described in accordance with the following numbered clauses.
Clause 1. A method implemented by a computing system for facilitating iterative prompt validation for code completion, the method comprising: the computing system generating a prompt for code development, the prompt based on and user input entered at a code development interface as well as code context of a codebase being developed with the code development interface; the computing system sending a request with the prompt to one or more remote services and/or models capable of processing the request and capable of generating a response based on the prompt, the response including suggested code for the codebase being developed; the computing system, prior to the suggested code being displayed at the code development interface, performing one or more validation tests with the suggested code; the computing system, in response to a fail event associated with the suggested code failing the one or more validation tests: refraining from displaying the suggested code at the code development interface; updating the prompt based on the fail event; causing a new request to be generated and transmitted to the one or more remote services and/or models based on the updated prompt; and receiving a new response based on the new request, the new response including new suggested code; the computing system, prior to the new suggested code being displayed at the code development interface, performing the one or more validation tests with the new suggested code; and the computing system, in response to the one or more validation tests being successfully performed with the new suggested code, causing the new suggested code to be displayed at the code development interface.
Clause 2. The method of clause 1, wherein the one or more validation tests comprises a language services syntactic test.
Clause 3. The method of clause 1, wherein one or more validation tests comprises a semantic test.
Clause 4. The method of clause 1, wherein one or more validation tests comprises a compile test.
Clause 5. The method of clause 1, wherein one or more validation tests comprises a compiled code runtime execution test.
Clause 6. The method of clause 1, wherein the method further includes the computing system, in response to identifying a user-initiated event that suggests a rejection of the new suggested code: generating a newly updated prompt based on the updated prompt and the user-initiated event; causing a subsequent request to be generated and transmitted to the one or more remote services and/or models based on the newly updated prompt; and receiving a subsequent response based on the subsequent request, the subsequent response including new suggested code; and prior to the new suggested code being displayed at the code development interface, performing the one or more validation tests with the new suggested code.
Clause 7. The method of clause 6, wherein the method further includes the computing system, in response to the one or more validation tests being successfully performed with the new suggested code, causing the new suggested code to be displayed at the code development interface.
Clause 8. The method of clause 7, wherein the method further includes the computing system detecting user input rejecting the new suggested code and deleting the new suggested code from the code development interface or, alternatively, detecting user input accepting the new suggested code and incorporating the new suggested code into the codebase at the code development interface.
Clause 9. The method of clause 6, wherein the method further includes the computing system, in response to a new fail event associated with the new suggested code failing the one or more validation tests: refraining from displaying the new suggested code at the code development interface; updating the prompt based on the new fail event; causing a subsequent new request to be generated and transmitted to the one or more remote services and/or models based on the updated prompt; and receiving a subsequent new response based on the subsequent new request, the subsequent new response including subsequent new suggested code.
Clause 10. A computing system comprising: one or more hardware processor; and one or more hardware storage device having stored computer-executable instructions that are executable by the one or more hardware processor to cause the computing system to implement a method for facilitating iterative prompt validation for code completion, the method comprising: the computing system generating a prompt for code development, the prompt based on and user input entered at a code development interface as well as code context of a codebase being developed with the code development interface; the computing system sending a request with the prompt to one or more remote services and/or models capable of processing the request and generating a response based on the prompt, the response including suggested code; the computing system, prior to the suggested code being displayed at the code development interface, performing one or more validation tests with the suggested code; the computing system, in response to a fail event associated with the suggested code failing the one or more validation tests: refraining from displaying the suggested code at the code development interface; updating the prompt based on the fail event; causing a new request to be generated and transmitted to the one or more remote services and/or models based on the updated prompt; and receiving a new response based on the new request, the new response including new suggested code; the computing system, prior to the new suggested code being displayed at the code development interface, performing the one or more validation tests with the new suggested code; the computing system, in response to the one or more validation tests being successfully performed with the new suggested code, causing the new suggested code to be displayed at the code development interface.
Clause 11. The computing system of clause 10, wherein the one or more validation tests comprises a language services syntactic test.
Clause 12. The computing system of clause 10, wherein one or more validation tests comprises a semantic test.
Clause 13. The computing system of clause 10, wherein one or more validation tests comprises a compile test.
Clause 14. The computing system of clause 10, wherein one or more validation tests comprises a compiled code runtime execution test.
Clause 15. The computing system of clause 10, wherein the method further includes the computing system, in response to identifying a user-initiated event that suggests a rejection of the new suggested code: generating a newly updated prompt based on the updated prompt and the user-initiated event; causing a subsequent request to be generated and transmitted to the one or more remote services and/or models based on the newly updated prompt; and receiving a subsequent response based on the subsequent request, the subsequent response including new suggested code; prior to the new suggested code being displayed at the code development interface, performing the one or more validation tests with the new suggested code.
Clause 16. The computing system of clause 15, wherein the method further includes the computing system, in response to the one or more validation tests being successfully performed with the new suggested code, causing the new suggested code to be displayed at the code development interface.
Clause 17. The method of clause 16, wherein the method further includes the computing system detecting user input rejecting the new suggested code and deleting the new suggested code from the code development interface or, alternatively, detecting user input accepting the new suggested code and incorporating the new suggested code into the codebase at the code development interface.
Clause 18. The computing system of clause 15, wherein the method further includes the computing system, in response to a new fail event associated with the new suggested code failing the one or more validation tests: refraining from displaying the new suggested code at the code development interface; updating the prompt based on the new fail event; causing a subsequent new request to be generated and transmitted to the one or more remote services and/or models based on the updated prompt; and receiving a subsequent new response based on the subsequent new request, the subsequent new response including subsequent new suggested code.

What is claimed:

1. A method implemented by a computing system for facilitating iterative prompt validation for code completion, the method comprising:
the computing system generating a prompt for code development, the prompt based on and user input entered at a code development interface as well as code context of a codebase being developed with the code development interface;
the computing system sending a request with the prompt to one or more remote services and/or models capable of processing the request and capable of generating a response based on the prompt, the response including suggested code for the codebase being developed;
the computing system, prior to the suggested code being displayed at the code development interface, performing one or more validation tests with the suggested code;
the computing system, in response to a fail event associated with the suggested code failing the one or more validation tests:
refraining from displaying the suggested code at the code development interface;
updating the prompt based on the fail event;
causing a new request to be generated and transmitted to the one or more remote services and/or models based on the updated prompt; and
receiving a new response based on the new request, the new response including new suggested code;
the computing system, prior to the new suggested code being displayed at the code development interface, performing the one or more validation tests with the new suggested code; and
the computing system, in response to the one or more validation tests being successfully performed with the new suggested code, causing the new suggested code to be displayed at the code development interface.

2. The method of claim 1, wherein the one or more validation tests comprises a language services syntactic test.

3. The method of claim 1, wherein one or more validation tests comprises a semantic test.

4. The method of claim 1, wherein one or more validation tests comprises a compile test.

5. The method of claim 1, wherein one or more validation tests comprises a compiled code runtime execution test.

6. The method of claim 1, wherein the method further includes the computing system, in response to identifying a user-initiated event that suggests a rejection of the new suggested code:
generating a newly updated prompt based on the updated prompt and the user-initiated event;
causing a subsequent request to be generated and transmitted to the one or more remote services and/or models based on the newly updated prompt; and
receiving a subsequent response based on the subsequent request, the subsequent response including new suggested code; and
prior to the new suggested code being displayed at the code development interface, performing the one or more validation tests with the new suggested code.

7. The method of claim 6, wherein the method further includes the computing system, in response to the one or more validation tests being successfully performed with the new suggested code, causing the new suggested code to be displayed at the code development interface.

8. The method of claim 7, wherein the method further includes the computing system detecting user input rejecting the new suggested code and deleting the new suggested code from the code development interface or, alternatively, detecting user input accepting the new suggested code and incorporating the new suggested code into the codebase at the code development interface.

9. The method of claim 6, wherein the method further includes the computing system, in response to a new fail event associated with the new suggested code failing the one or more validation tests:
refraining from displaying the new suggested code at the code development interface;
updating the prompt based on the new fail event;
causing a subsequent new request to be generated and transmitted to the one or more remote services and/or models based on the updated prompt; and
receiving a subsequent new response based on the subsequent new request, the subsequent new response including subsequent new suggested code.

10. A computing system comprising:
one or more hardware processor; and
one or more hardware storage device having stored computer-executable instructions that are executable by the one or more hardware processor to cause the computing system to implement a method for facilitating iterative prompt validation for code completion, the method comprising:
the computing system generating a prompt for code development, the prompt based on and user input entered at a code development interface as well as code context of a codebase being developed with the code development interface;
the computing system sending a request with the prompt to one or more remote services and/or models capable of processing the request and generating a response based on the prompt, the response including suggested code;
the computing system, prior to the suggested code being displayed at the code development interface, performing one or more validation tests with the suggested code;
the computing system, in response to a fail event associated with the suggested code failing the one or more validation tests:
refraining from displaying the suggested code at the code development interface;
updating the prompt based on the fail event;
causing a new request to be generated and transmitted to the one or more remote services and/or models based on the updated prompt; and
receiving a new response based on the new request, the new response including new suggested code;
the computing system, prior to the new suggested code being displayed at the code development interface, performing the one or more validation tests with the new suggested code;
the computing system, in response to the one or more validation tests being successfully performed with the new suggested code, causing the new suggested code to be displayed at the code development interface.

11. The computing system of claim 10, wherein the one or more validation tests comprises a language services syntactic test.

12. The computing system of claim 10, wherein one or more validation tests comprises a semantic test.

13. The computing system of claim 10, wherein one or more validation tests comprises a compile test.

14. The computing system of claim 10, wherein one or more validation tests comprises a compiled code runtime execution test.

15. The computing system of claim 10, wherein the method further includes the computing system, in response to identifying a user-initiated event that suggests a rejection of the new suggested code:
generating a newly updated prompt based on the updated prompt and the user-initiated event;
causing a subsequent request to be generated and transmitted to the one or more remote services and/or models based on the newly updated prompt; and
receiving a subsequent response based on the subsequent request, the subsequent response including new suggested code;
prior to the new suggested code being displayed at the code development interface, performing the one or more validation tests with the new suggested code.

16. The computing system of claim 15, wherein the method further includes the computing system, in response to the one or more validation tests being successfully performed with the new suggested code, causing the new suggested code to be displayed at the code development interface.

17. The method of claim 16, wherein the method further includes the computing system detecting user input rejecting the new suggested code and deleting the new suggested code from the code development interface or, alternatively, detecting user input accepting the new suggested code and incorporating the new suggested code into the codebase at the code development interface.

18. The computing system of claim 15, wherein the method further includes the computing system, in response to a new fail event associated with the new suggested code failing the one or more validation tests:
refraining from displaying the new suggested code at the code development interface;
updating the prompt based on the new fail event;
causing a subsequent new request to be generated and transmitted to the one or more remote services and/or models based on the updated prompt; and
receiving a subsequent new response based on the subsequent new request, the subsequent new response including subsequent new suggested code.
